(19) United States
(12) Patent Application Publication
(10) Pub. No.: US 2008/0003390 A1
(43) Pub. Date: Jan. 3, 2008

(54) Multi-Layer Structure and Process for Production Thereof

(76) Inventors: Nahoto Hayashi, Zwijndrecht (BE); Hiroyuki Shindome, Okayama (JP); Tomoyuki Watanabe, Okayama (JP); Naoki Kataoka, Okayama (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/587,981

(22) PCT Filed: Apr. 27, 2005
(86) PCT No.: PCT/JP05/08018

§ 371 Date: Oct. 30, 2006

(51) Int. Cl. B32B 27/08; B29B 7/00

(52) U.S. Cl. 428/36.6; 264/328.1; 428/340; 428/515

(57) ABSTRACT

A multi-layer structure comprising a layer of an ethylene-vinyl alcohol copolymer (A), a layer of a carboxylic acid-modified polyolefin (B), a layer of a thermoplastic resin (C) having a solubility parameter of 11 or less, and a layer of a resin composition (E), wherein the resin composition (E) comprises an ethylene-vinyl alcohol copolymer (A), a carboxylic acid-modified polyolefin (B), a thermoplastic resin (C) and a thermoplastic resin (D) having at least one functional group selected from the group consisting of a boronic acid group and boron-containing groups capable of being converted into a boronic acid group in the presence of water, and the layer of an ethylene-vinyl alcohol copolymer (A) is laminated with the layer of a thermoplastic resin (C) or the layer of a resin composition (E) through the layer of a carboxylic acid-modified polyolefin (B). This provides a multi-layer structure which allows effective reuse of regrind and which is excellent in impact resistance and gas barrier properties.

### TECHNICAL FIELD

The present invention relates to a multi-layer structure containing an ethylene-vinyl alcohol copolymer layer and to a process for production thereof.

### BACKGROUND ART

Ethylene-vinyl alcohol copolymer (hereinafter, sometimes abbreviated as EVOH) has excellent gas barrier properties and therefore has been used as a material for packaging contents whose quality maintenance is regarded as important, such as foods and pharmaceuticals. In recent years, it has been widely used for fuel tanks by taking advantage of its excellent gasoline barrier property. In particular, its laminates with thermoplastic resin excellent in moisture-proofing property and mechanical properties, such as polyolefin resin, are suitably used because they can make up weak points of EVOH. In manufacture of such a multi-layer structure, regrind (or scrap), such as wastes or chips of products or defective products when the multi-layer structure is in a form of sheet, film and the like, burrs when in a form of bottle and the like, and punching wastes when in a form of cup and the like, will be produced inevitably. Reuse of such regrind is required from the viewpoint of cost and resource saving.

For effectively reusing such regrind, there have been proposed, for example, a method of using regrind by mixing it into a resin layer composed mainly of a polyolefin resin (see Patent Document 1) and a method of disposing a regrind composition layer between a thermoplastic polyolefin layer and an EVOH layer (see Patent Document 2). Examples of layer structures of common gasoline tanks for automobiles comprising high-density polyethylene, a barrier layer, an adhesive layer and a regrind composition layer include (outer layer) regrind+high-density polyethylene layer/adhesive layer/barrier layer/adhesive layer/regrind+high-density polyethylene layer (inner layer), and (outer layer) high-density polyethylene layer/regrind composition layer/adhesive layer/barrier layer/adhesive layer/high-density polyethylene layer (inner layer).

In order to inhibit occurrence of interfacial delamination, turbulence and wavy pattern in a regrind composition layer and to produce a laminate excellent in impact resistance, a method of mixing a specific block copolymer or graft polymer (e.g., carboxylic acid-modified polyolefin) to a regrind composition (see Patent Documents 3 and 4) and a method of mixing an antioxidant and a metal compound (see Patent Document 5) are also known.

However, even if these methods are adopted, when a regrind composition including a polyolefin resin and EVOH is subjected to melt extrusion molding, EVOH in the regrind composition particularly tends to stay to deteriorate. As a result, the fact is that it is often difficult to conduct extrusion molding of a regrind composition continuously due to occurrence of black spot (scorch) inside an extruder or generation of gelled matters (build up) at die lips.

As a method for improving the above-mentioned problems, a method of reducing abnormal appearance or gels and hard spots in a regrind composition using, as an adhesive layer, a thermoplastic resin having boronic acid group or a boron containing group capable of being converted into a boronic acid group in the presence of water is known (Patent Document 6). Use of this method reduces the occurrence of abnormal appearance of a regrind composition. When the thermoplastic resin having a boron-containing group is used as an adhesive layer, however, the layer will exhibit too high adhesion with an EVOH layer. It is therefore feared that the surface appearance of multi-layer structures or molding processability will be adversely affected in comparison to use of carboxylic acid-modified polyolefin or the like as an adhesive layer. In particular, in production of large multi-layer containers such as fuel containers by blow molding, it cannot be denied that too great improvement in adhesion will affect molding processability (draw-down property) of parisons adversely. In addition, use of the thermoplastic resin as an adhesive layer may lead to increase in cost. Therefore, use of carboxylic acid-modified polyolefin as an adhesives layer is preferred in respect of molding processability and cost.

As mentioned above, in the case of melt kneading a regrind composition obtained when a multi-layer structure having a carboxylic acid-modified polyolefin layer is recovered, however, EVOH in the regrind composition tends to stay to deteriorate. As a result, the fact is that it is often difficult to conduct extrusion molding of a regrind composition continuously for a long time due to occurrence of black spot (scorch) inside an extruder or generation of gelled matters (build up) at die lips.

Patent Document 1: Japanese Unexamined Patent Publication No. 51-95478

Patent Document 2: Japanese Unexamined Patent Publication No. 59-101338

Patent Document 1: Japanese Unexamined Patent Publication No. 5-147177

Patent Document 4: Japanese Unexamined Patent Publication No. 8-27332

Patent Document 5: Japanese Unexamined Patent Publication No. 9-302170

Patent Document 6: Japanese Unexamined Patent Publication No. 7-329252

### DISCLOSURE OF THE INVENTION

### Problem to be Solved by the Invention

The present invention was made in order to solve the problems mentioned above. An object of the present invention is to obtain a multi-layer structure excellent in impact resistance, gas barrier properties and appearance. Another object of the present invention is to provide a method for producing a multi-layer structure excellent in thermal stability and melt molding processability in which regrind can be used effectively.

### Means for Solving Problems

The above-mentioned problem is solved by providing a multi-layer structure comprising a layer of an ethylene-vinyl alcohol copolymer (A) having an ethylene content of 5 to 60 mol % and a degree of saponification of 85% or more, a layer of a carboxylic acid-modified polyolefin (B), a layer of a thermoplastic resin (C) having a solubility parameter, calculated from the Fedors' equation, of 11 or less, and a layer of a resin composition (E), wherein the resin composition (E) comprises an ethylene-vinyl alcohol copolymer (A), a carboxylic acid-modified polyolefin (B), a thermoplastic resin (C) and a thermoplastic resin (D) having at least one functional group selected from the group consisting of a boronic acid group and boron-containing groups capable of being converted into a boronic acid group in the presence of water, and wherein the layer of an ethylene-vinyl alcohol copolymer (A) and the layer of a thermoplastic resin (C) or the layer of a resin composition (E) are laminated through the layer of a carboxylic acid-modified polyolefin (B).

It is preferable that the resin composition (E) comprises 1 to 40% by weight of an ethylene-vinyl alcohol copolymer (A), 0.1 to 39.1% by weight of a carboxylic acid-modified polyolefin (B), 59.8 to 98.8% by weight of a thermoplastic resin (C) and 0.1 to 39.1% by weight of a thermoplastic resin (D). It is also preferable that the thermoplastic resin (C) is a substantially unmodified polyolefin. It is also preferable that the content of boron-containing groups in the thermoplastic resin (D) is 0.001 to 2 meq/g. It is also preferable that the thermoplastic resin (D) is a polyolefin having at least one functional group selected from the group consisting of a boronic acid group and boron-containing groups capable of being converted into a boronic acid group in the presence of water, especially, a polyethylene having a density of from 0.85 to 0.94 g/cm³.

Extrusion molded articles, blow molded articles, thermoformed articles and fuel containers, comprising the above-mentioned multi-layer structure, are preferable embodiments of the present invention.

The above-mentioned problem is also solved by providing a method for producing the aforementioned multi-layer structure comprising adding a thermoplastic resin (D) to a regrind obtained from a multi-layer structure comprising a layer of an ethylene-vinyl alcohol copolymer (A), a layer of a carboxylic acid-modified polyolefin (B) and a layer of a thermoplastic resin (C) followed by melt-kneading to form the layer of a resin composition (E).

It is preferable that the regrind is one obtained from a multi-layer structure further comprising a layer of a resin composition (E) in addition to the layer of an ethylene-vinyl alcohol copolymer (A), the layer of a carboxylic acid-modified polyolefin (B) and the layer of a thermoplastic resin (C). It is also preferable that the thermoplastic resin (D) is added in an amount of 0.1 to 30 parts by weight based on 100 parts by weight in total of the regrind and the thermoplastic resin (D) to be added thereto, followed by melt-kneading. Further, co-extrusion molding or co-injection molding is also preferable.

When recycling a regrind of a multi-layer structure comprising a layer of an ethylene-vinyl alcohol copolymer (A), a layer of a carboxylic acid-modified polyolefin (B) and a layer of a thermoplastic resin (C), addition of a thermoplastic resin (D) having at least one functional group selected from the group consisting of a boronic acid group and boron-containing groups capable of being converted into a boronic acid group in the presence of water to the regrind, followed by melt kneading will improve the compatibility of the EVOH (A), the carboxylic acid-modified polyolefin (B) and the thermoplastic resin (C) in the resulting resin composition (E) obtained. As a result, impact resistance and thermal stability will improved dramatically. Although the reason for this is not clear, it is presumed that it is because a boron-containing functional group in the thermoplastic resin and a hydroxyl group in the EVOH (A) are bonded by transesterification during the melt kneading.

Heretofore, carboxylic acid-modified polyolefin (B) in a regrind composition was thermally degraded more and more with each regrind, and its compatibility with EVOH (A) in a regrind composition falls gradually, leading to deterioration of dispersibility of the EVOH (A). As a result, the EVOH (A) in a regrind composition suffered from aggregation or thermal degradation. However, it has been found that when a regrind is added to a thermoplastic resin (D) having a boron-containing functional group, deterioration of dispersibility of an EVOH (A) in a regrind composition is prevented and aggregation or thermal degradation of the EVOH (A) in the regrind composition is inhibited even if the number of recoveries is increased. Although the reason for this is not clear, it is presumed that it is because the decrease in dispersiblity of the EVOH (A) in a regrind composition caused by thermal degradation of the carboxylic acid-modified polyolefin (B) is prevented by the thermoplastic resin (D) having a boron-containing functional group in the regrind composition. Therefore, the improving effect of regrind property resulting from addition of a regrind to a thermoplastic resin (D) having a boron-containing functional group is shown more notably when the number of recoveries is increased.

### EFFECT OF THE INVENTION

The multi-layer structure of the present invention is excellent in impact resistance, gas barrier property and appearance. In addition, when recycling a regrind of a multi-layer structure having a layer of an ethylene-vinyl alcohol copolymer (A), a layer of a carboxylic acid-modified polyolefin (B) and a layer of a thermoplastic resin (C), addition of a thermoplastic resin (D) having a boron-containing group to the regrind will improve melt molding processability and thermal stability of a regrind composition and also will improve impact strength of multi-layer structures dramatically.

### BEST MODE FOR CARRYING OUT THE INVENTION

The present invention will be described in detail below. The EVOH (A) for use in the present invention is preferably a product obtained by saponifying an ethylene-vinyl ester copolymer. Although a representative example of the vinyl ester is vinyl acetate, vinyl esters of fatty acids, such as vinyl propionate and vinyl pivalate, may also be used.

The ethylene content in EVOH (A) must be from 5 to 60 mol %. The lower limit of the ethylene content is preferably 15 mol % or more, and more preferably 20 mol % or more. The upper limit of the ethylene content is preferably 55 mol % or less, and more preferably 50 mol % or less. When the ethylene content of the EVOH is less than 5 mol %, the melt molding processability of the resin composition including the EVOH is poor. On the other hand, when the ethylene content exceeds 60 mol %, the barrier property of the resin composition including the EVOH is insufficient.

The degree of saponification of the vinyl ester component of EVOH (A) must be 85% or more. The degree of saponification is preferably 90% or more, and more preferably 99% or more. When the degree of saponification is less than 85%, the barrier properties and thermal stability of the resin composition including the EVOH become insufficient.

In preparation of EVOH (A), a known method comprising copolymerizing ethylene and one or two or more kinds of vinyl esters and saponifying the resulting ethylene-vinyl acetate copolymer may be employed. A vinylsilane compound may be contained at an amount of from 0.0002 to 0.2 mol % as a third comonomer. Examples of such a vinylsilane compound include vinyltrimethoxysilane, vinyltriethoxysilane, vinyltri(β-methoxy-ethoxy)silane and γ-methacryloxypropylmethoxysilane. Among these, vinyltrimethoxysilane and vinyltriethoxysilane are suitably employed. Moreover, other monomers, for example, α-olefins such as propylene and butylene; unsaturated carboxylic acids and their esters such as (meth)acrylic acid, methyl (meth)acrylate and ethyl (meth)acrylate; and pyrrolidones such as N-vinylpyrrolidone, may be copolymerized, unless the object of the present invention is inhibited.

EVOH (A) may be a mixture of two or more different EVOHs. In this case, the ethylene content and the degree of saponification of EVOH (A) are average values calculated from a compounding weight ratio.

EVOH (A) may include a boron compound, unless the object of the present invention is affected. Examples of such a boron compound include boric acids, boric acid esters, boric acid salts and boron hydrides. Specifically, examples of the boric acids include orthoboric acid, metaboric acid and tetraboric acid. Examples of the boric acid esters include triethyl borate and trimethyl borate. Examples of the boric acid salts include alkali metal salts and alkaline earth metal salts of various types of aforesaid boric acids and borax. Among these compounds, orthoboric acid is preferred.

When a boron compound is blended, the content of the boron compound is preferably from 20 to 2000 ppm, and more preferably from 50 to 1000 ppm in terms of boron element. When the content of a boron compound is within such a range, torque fluctuation during heat melting of an EVOH is inhibited. When the content of a boron compound is less than 20 ppm, the effect of improving the inhibition of torque fluctuation may be insufficient. When it exceeds 2000 ppm, the EVOH may tend to gelate and result in defective molding processability.

In the case of using EVOH (A) singly as one layer constituting a multi-layer structure as described later, it is also preferable to cause the EVOH (A) to contain an alkali metal salt because it is effective for improving interlayer adhesion and the like. The content of the alkali metal salt is preferably from 5 to 5000 ppm, more preferably from 20 to 1000 ppm, and even more preferably from 30 to 500 ppm in terms of alkali metal element. Examples of alkali metal include lithium, sodium and potassium. Examples of alkali metal salts include aliphatic carboxylic acid salts, aromatic carboxylic acid salts, phosphoric acid salts and metal complexes. Specific examples are sodium acetate, potassium acetate, sodium phosphate, lithium phosphate, sodium stearate, potassium stearate, sodium ethylenediaminetetraacetate. Among these, sodium acetate, potassium acetate and sodium phosphate are preferred.

Addition of a phosphorus compound to EVOH (A) is also preferable because it can improve the melt molding processability and thermal stability of the EVOH (A). The content of the phosphorus compound is preferably from 2 to 200 ppm, more preferably from 3 to 150 ppm, and even more preferably from 5 to 100 ppm in terms of phosphorus element. When the content of the phosphorus compound is less than 2 ppm or more than 200 ppm, problems may arise with respect to the melt molding processability or thermal stability of the EVOH. In particular, in melt molding for a long time, problems such as generation of gel-like hard spots and yellowing tend to be caused.

The kind of the phosphorus compound to be added to EVOH (A) is not particularly restricted. For example, acids, such as phosphoric acid and phosphorous acid, and their salts can be used. Phosphoric acid salts may be added in any form of primary phosphate, secondary phosphate and tertiary phosphate. The kind of their cations is also not particularly restricted, but alkali metal salts and alkaline earth metal salts are preferred. In particular, addition of a phosphorus compound in the form of sodium dihydrogenphosphate, potassium dihydrogenphosphate, disodium hydrogenphosphate or dipotassium hydrogenphosphate is preferred.

It is also permissible to add heat stabilizers, UV absorbers, antioxidants, colorants and plasticizers such as glycerol and glycerol monostearate to EVOH (A), unless the object of the present invention is inhibited. Addition of a metal salt of a higher aliphatic carboxylic acid or a hydrotalcite compound is effective from a viewpoint of preventing the degradation of EVOH (A) due to heat.

Examples of the metal salt of a higher aliphatic carboxylic acid include metal salts of higher aliphatic carboxylic acids having 8 to 22 carbon atoms. Specific examples are lauric acid, stearic acid and myristic acid. Examples of the metal include sodium, potassium, magnesium, calcium, zinc, barium and aluminum. Among these, magnesium, calcium and barium are preferred.

Examples of the hydrotalcite compound include hydrotalcite compounds which are double salts represented by MₓAl_{y}(OH)_{2x+3y-2z}(A)_{z}.aH2 (M represents Mg, Ca or Zn, A represents CO₃ or HPO₄, and x, y, z and a are positive numbers). Preferable examples are the hydrotalcite compounds shown below.

Mg₆Al₂(OH)₁₆CO₃.4H₂O

Mg₈Al₂(OH)₂₀CO₃.5H₂O

Mg₅Al₂(OH)₁₄CO₃.4H₂O

Mg₁₀Al₂(OH)₂₂(CO₃)₂.4H₂O

Mg₆Al₂(OH)₁₆HPO₄.4H₂O

Ca₆Al₂(OH)₁₆CO₃.4H₂O

Zn₆Al₂(OH)₁₆CO₃.4H₂O

Mg_{4.5}Al₂(OH)₁₃CO₃.5H₂O

Besides the compounds provided above as examples, hydrotalcite-based solid solution like [Mg_{0.75}Zn_{0.25}]_{0.67}Al_{0.33}(OH)₂(CO₃)_{0.167}.0.45H₂O disclosed in Japanese Unexamined Patent publication No. 1-308439 may also be used.

The content of such a metal salt of a higher aliphatic carboxylic acid or a hydrotalcite is preferably from 0.01 to 3 parts by weight, and more preferably from 0.05 to 2.5 parts by weight based on 100 parts by weight of EVOH (A).

The melt flow rate (MFR) (at 190° C., under 2160 g load) of EVOH (A) is preferably from 0.1 to 50 g/10 minutes, more preferably from 0.3 to 40 g/10 minutes, and even more preferably from 0.5 to 30 g/10 minutes. It is noted that for an EVOH having a melting point of about 190° C. or over 190° C., the measurements are carried out under 2160 g load at a plurality of temperatures not lower than the melting point. The results are plotted, in a semilog graph, with reciprocals of absolute temperatures as abscissa against logarithms of MFRs as ordinate and the MFR is represented by an extrapolation to 190° C.

As the carboxylic acid-modified polyolefin (B) for use in the present invention, in particular, copolymers composed of an α-olefin and an unsaturated carboxylic acid or its anhydride are suitably used. However, besides such copolymers, polyolefin having carboxyl groups in the molecule and polyolefin having carboxyl groups all or a portion of which are in the form of metal salt can also be used. Examples of polyolefin which serves as a base of carboxylic acid-modified polyolefin (B) include various types of polyolefin such as polyethylene (e.g., high density polyethylene (HDPE), low density polyethylene (LDPE), linear low density polyethylene (LLDPE) and very low density polyethylene (VLDPE)), polypropylene, copolymerized polypropylene, ethylene-vinyl acetate copolymers and ethylene-(meth)acrylic acid ester copolymers.

Examples of the unsaturated carboxylic acid, which is a copolymerization component, include acrylic acid, methacrylic acid, ethacrylic acid, maleic acid, monomethyl maleate, monoethyl maleate and itaconic acid. Among these, acrylic acid and methacrylic acid are preferred. The content of the unsaturated carboxylic acid is preferably from 0.5 to 20 mol %, more preferably from 2 to 15 mol %, and even more preferably from 3 to 12 mol %. Examples of unsaturated carboxylic acid anhydride include itaconic anhydride and maleic anhydride. Among these, maleic anhydride is preferred. The content of the unsaturated carboxylic acid anhydride is preferably from 0.0001 to 5 mol %, more preferably from 0.0005 to 3 mol %, and even more preferably from 0.001 to 1 mol %.

Examples of the metal ion in a metal salt of carboxylic acid-modified polyolefin include alkali metals such as lithium, sodium and potassium; alkaline earth metals such as magnesium and calcium; and transition metals such as zinc. The degree of neutralization in the metal salt of carboxylic acid-modified polyolefin is preferably 100% or less, more preferably 90% or less, and even more preferably 70% or less; and preferably 5% or more, more preferably 10% or more, and even more preferably 30% or more.

The carboxylic acid-modified polyolefin (B) may include monomers other than those provided above as copolymerization components. Examples of such other monomers include vinyl esters such as vinyl acetate and propionic acid vinyl; unsaturated carboxylic acid esters such as methyl acrylate, ethyl acrylate, isopropyl acrylate, isobutyl acrylate, n-butyl acrylate, 2-ethylhexyl acrylate, methyl methacrylate, isobutyl methacrylate and diethyl maleate; and carbon monoxide.

The melt flow rate (MFR) (at 190° C., under 2160 g load) of carboxylic acid-modified polyolefin (B) is preferably 0.01 g/10 minutes or more, more preferably 0.05 g/10 minutes or more, and even more preferably 0.1 g/10 minutes or more. The MFR is preferably 50 g/10 minutes or less, more preferably 30 g/10 minutes or less, and even more preferably 10 g/10 minutes or less. Such carboxylic acid-modified polyolefins may be used singly or in combination of two or more kinds.

Examples of the thermoplastic resin (C) having a solubility parameter, calculated from the Fedors' equation, of 11 or less for use in the present invention include polyolefin resin, styrene-based resin and polyvinyl chloride-based resin. Examples of the polyolefin resin include homopolymers of α-olefin such as high density polyethylene, low density polyethylene, polypropylene, polybutene-1; copolymers of different α-olefins selected from ethylene, propylene, butene-1, hexene-1, etc.; and copolymers of α-olefin like those listed above with a diolefin, a vinyl compound such as vinyl chloride and vinyl acetate, or an unsaturated carboxylic acid ester such as acrylic acid ester and methacrylic acid ester. Examples of the styrene-based resin include polystyrene, acrylonitrile-butadiene-styrene copolymer resin (ABS), acrylonitrile-styrene copolymer resin (AS), styrene-isobutylene block copolymer, styrene-butadiene copolymer and styrene-isoprene block copolymer. Such thermoplastic resin (C) may be used singly or in combination of two or more kinds. The thermoplastic resin (C) is a resin other than the carboxylic acid-modified polyolefin (B) and the thermoplastic resin (D) having at least one functional group selected from the group consisting of a boronic acid group and boron-containing groups capable of being converted into a boronic acid group in the presence of water, the resin having the solubility parameter mentioned above.

Thermoplastic resin (C) is suitable as a main component of the resin composition (E) because it is well balanced with respect to various properties and also because there are so many kinds of commercially available products that it is easy to obtain it and it is at low price. In addition, since such thermoplastic resin (C) is used as a main layer of many multi-layer structures for the same reason as mentioned above, it is contained inevitably in a regrind when such multi-layer structures are recovered and reused. For example, in a fuel container application, polyolefin resin, which is one of the above-mentioned thermoplastic resin (C), is used often for forming an outermost layer from the viewpoint of impact resistance. Therefore, the polyolefin resin is contained also in a regrind recovered. Preferably used as thermoplastic resin (C) is a substantially unmodified polyolefin. Substantially unmodified means that no functional groups containing elements other than carbon and hydrogen have been introduced intentionally.

The melt flow rate (MFR) (at 190° C., under 2160 g load) of thermoplastic resin (C) is preferably 0.01 g/10 minutes or more, and more preferably 0.02 g/10 minutes or more. The MFR is preferably 5 g/10 minutes or less, and more preferably 2 g/10 minutes or less. In particular, since a high density polyethylene used in fuel containers is required to have high impact resistance, the MFR thereof is preferably low and is preferably 0.3 g/10 minutes or less, and more preferably 0.1 g/10 minutes or less. When using a resin having such a high viscosity, use of the present invention is very advantageous because it is, in many cases, difficult to recycle the resin. Such thermoplastic resin (C) may be used singly or in combination of two or more kinds.

In the thermoplastic resin (D) having a boron-containing functional group, a boronic acid group is a group represented by the following formula (I).

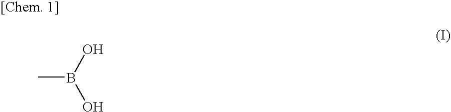

The boron-containing group capable of being converted into a boronic acid group in the presence of water indicates a boron-containing group that can be hydrolyzed in the presence of water to be converted into a boronic acid group represented by the above formula (I). More specifically, the boron-containing group capable of being converted into a boronic acid group in the presence of water means a functional group that can be converted into a boronic acid group when being hydrolyzed under conditions of from room temperature to 150° C. for from 10 minutes to 2 hours by use, as a solvent, of water only, a mixture of water and an organic solvent (e.g., toluene, xylene and acetone), a mixture of a 5% aqueous boric acid solution and the above described organic solvent, or the like. Representative examples of such functional groups include boronic acid ester groups represented by the following general formula (II), boronic anhydride groups represented by the following general formula (III), and boronic acid salt groups represented by the following general formula (IV):

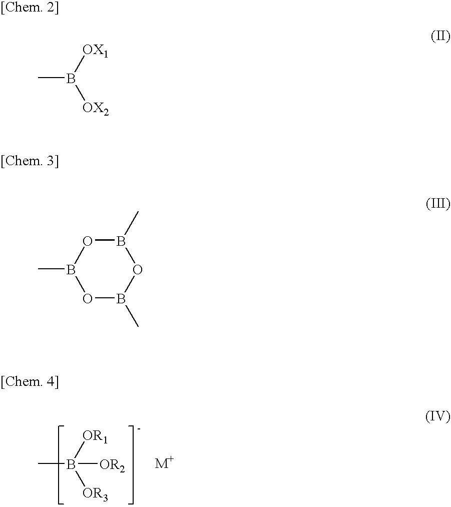

wherein X₁ and X₂ are the same or different and each represent a hydrogen atom, an aliphatic hydrocarbon group (e.g., a linear or branched alkyl or alkenyl group having from 1 to 20 carbon atoms), an alicyclic hydrocarbon group (e.g., a cycloalkyl group and a cycloalkenyl group), or an aromatic hydrocarbon group (e.g., a phenyl group and a biphenyl group), where the aliphatic hydrocarbon group, the alicyclic hydrocarbon group and the aromatic hydrocarbon group may have a substituent, X₁ and X₂ may be combined together, provided that in no cases both X₁ and X₂ are hydrogen atoms; R₁, R₂ and R₃ each represent a hydrogen atom, an aliphatic hydrocarbon group, an alicyclic hydrocarbon group or an aromatic hydrocarbon group, like X₁ and X₂ mentioned above, and M represents alkali metal. In the formulas shown above, examples of substituents the aliphatic hydrocarbon group, the alicyclic hydrocarbon group and the aromatic hydrocarbon group may have include a carboxyl group and a halogen atom.

Specific examples of the boronic acid ester group represented by general formula (II) include a dimethyl boronate group, a diethyl boronate group, a dipropyl boronate group, a diisopropyl boronate group, a dibutyl boronate group, a dihexyl boronate group, a dicyclohexyl boronate group, an ethylene glycol boronate group, a propylene glycol boronate group, a 1,3-propanediol boronate group, a 1,3-butanediol boronate group, a neopentyl glycol boronate group, a catechol boronate group, a glycerin boronate group, a trimethylolethane boronate group, a trimethylolpropane boronate group and a diethanolamine boronate group.

Examples of the boronic acid salt groups represented by general formula (IV) include alkali metal salts of boronic acid, specifically, a sodium boronate group and a potassium boronate group.

Among such boron-containing functional groups, cyclic boronate ester groups are preferred in view of thermal stability. Examples of cyclic boronate ester groups include 5-membered or 6-membered ring-containing cyclic boronate ester groups, specifically an ethylene glycol boronate group, a propylene glycol boronate group, a 1,3-propanediol boronate group, a 1,3-butanediol boronate group and a glycerin boronate group.

The content of boron-containing functional groups is not particularly limited, but it is preferably from 0.001 to 2 meq/g (mmol/g) based on the weight of the thermoplastic resin (D). When the content of boron-containing functional groups is less than 0.001 meq/g, the compatibility improving effect may be insufficient. Therefore, melt molding processability and thermal stability of a regrind composition may be insufficient and multi-layer structures may have insufficient impact strength. The content is more preferably 0.01 meq/g or more, and more preferably 0.04 meq/g or more. On the other hand, when the content of boron-containing functional groups exceeds 2 meq/g, gel may generate in a resin composition (E). The content is more preferably 0.5 meq/g or less, and even more preferably 0.2 meq/g or less.

Boron-containing functional groups are bonded to the main chain, a side chain or an end of the thermoplastic resin via a boron-carbon bond. In particular, embodiments where the functional group is linked to a side chain or an end are preferred. The embodiment where the functional group is linked to an end is more preferred. The end means one end or both ends. The carbon in a boron-carbon bond originates in a base polymer of the thermoplastic resin described later or in a boron compound which is caused to react with a base polymer.

Specific examples of the thermoplastic resin (D) having a boron-containing functional group include polyolefin resins such as polyethylene (very low density, low density, middle density, high density), ethylene-vinyl acetate copolymers, ethylene-acrylic acid ester copolymers, metal salts (Na, K, Zn ionomers) of ethylene-acrylic acid copolymers, polypropylene, ethylene-propylene copolymers and copolymers of ethylene with α-olefin such as 1-butene, isobutene, 3-methylpentene, 1-hexene and 1-octene; products resulting from graft modification of the aforementioned polyolefins with maleic anhydride, glycidyl methacrylate and the like; styrene resins such as polystyrene and styrene-acrylonitrile copolymers; styrene-hydrogenated diene block copolymer resins such as styrene-hydrogenated butadiene block copolymers, styrene-hydrogenated isoprene copolymers, styrene-hydrogenated butadiene-styrene block copolymers and styrene-hydrogenated isoprene-styrene block copolymers; (meth)acrylic acid ester resins such as polymethyl acrylate, polyethyl acrylate and polymethyl methacrylate; vinyl halide-based resins such as polyvinyl chloride and vinylidene fluoride; semiaromatic polyester resins such as polyethylene terephthalate and polybutylene terephthalate; aliphatic polyester resins such as polyvalerolactone, polycaprolactone, polyethylene succinate and polybutylene succinate. These may be used singly or in combination of two or more kinds. Among these, polyolefins and styrene-hydrogenated diene block copolymers are preferably used. Polyolefins are used particularly preferably.

Since hot water resistance is improved when a propylene-based polymer is used as thermoplastic resin (D) having a boron-containing functional group, it is very useful in applications where hot water resistance is required, such as retort packaging materials. Since impact resistance is improved when an ethylene-based polymer or a styrene-hydrogenated diene block copolymer resin is used as thermoplastic resin (D), it is useful in applications where impact resistance is required, such as packaging materials including bottles, tubes, cups and pouches. On the other hand, in applications of fuel containers such as gasoline tanks, it is preferable to use an ethylene-based polymer, which excels in fuel resistance, as thermoplastic resin (D). In particular, polyethylenes having a density of from 0.85 to 0.94 g/cm³ are preferred because they can afford multi-layer structures excellent in impact resistance. Since polyethylene having a lower density tends to improve impact resistance better, the density is more preferably 0.92 g/cm³ or less, and even more preferably 0.91 g/cm³ or less. When the polyethylene has a density less than 0.85 g/cm³, it may be difficult to handle it. Therefore, the density is more preferably 0.87 g/cm³ or more, and even more preferably 0.88 g/cm³ or more.

Next, a representative method for producing the thermoplastic resin (D) having a boron-containing functional group for use in the present invention is described.

First method: a method comprising causing a boran complex or trialkyl borate to react under a nitrogen atmosphere with a thermoplastic resin having an olefinic double bond to produce a thermoplastic resin having a dialkyl boronate group and then, if necessary, causing water or alcohol to react. In this way, a boron-containing functional group is introduced to the olefinic double bond of the thermoplastic resin by addition reaction.

An olefinic double bond is introduced, for example, to an end by disproportionation occurring at the time of termination of radical polymerization or into a main chain or a side chain by a side reaction occurring during polymerization. In particular, the aforementioned polyolefin resin is preferred because it is possible to introduce an olefinic double thereto easily by thermal decomposition under oxygen-free conditions or copolymerization of diene compounds. Styrene-hydrogenated diene block copolymer resin is preferred because it is possible to cause an olefinic double bond to remain moderately by controlling a hydrogenation reaction.

The content of double bonds in the thermoplastic resin used as a raw material is preferably from 0.01 to 2 meq/g, and more preferably from 0.02 to 1 meq/g. Use of such a raw material makes it easy to control the amount of boron-containing functional groups introduced. It will also become possible at the same time to control the amount of olefinic double bonds remaining after the introduction of functional groups.

Preferred examples of the borane complex are borane-tetrahydrofuran complex, borane-dimethylsulfide complex, borane-pyridine complex, borane-trimethylamine complex and borane-triethylamine complex. Among these, borane-dimethylsulfide complex, borane-trimethylamine complex and borane-triethylamine complex are more preferable. The amount of a borane complex to be supplied is preferably within the range of from ⅓ equivalents to 10 equivalents to the olefinic double bonds of the thermoplastic resin.

Preferred examples of the trialkyl borates are lower alkyl esters of boric acid such as trimethyl borate, triethyl borate, tripropyl borate and tributyl borate. The amount of a trialkyl borate to be supplied is preferably within the range of from 1 to 100 equivalents to the olefinic double bonds of the thermoplastic resin. There is no need to use a solvent. When use a solvent, however, a saturated hydrocarbon solvent, such as hexane, heptane, octane, decane, dodecane, cyclohexane, ethylcyclohexane and decalin, is preferred. The reaction temperature is typically within the range of from room temperature to 300° C., and preferably from 100 to 250° C. It is recommended to carry out a reaction at a temperature within such ranges for 1 minute to 10 hours, preferably for 5 minutes to 5 hours.

The dialkyl boronate group introduced to a thermoplastic resin through the above described reaction can be hydrolyzed to a boronic acid group by a known method. It is also allowed to undergo transesterification with an alcohol by a known method to form a boronate group. Further, it can be allowed to undergo dehydration condensation by heating to form a boronic anhydride group. Furthermore, it can be allowed to react with a metal hydroxide or a metal alcoholate to form a boronic acid salt group.

Such conversion of a boron-containing functional group is typically carried out using an organic solvent such as toluene, xylene, acetone and ethyl acetate. Examples of the alcohols include monoalcohols such as methanol, ethanol and butanol; and polyhydric alcohols such as ethylene glycol, propylene glycol, 1,3-propanediol, 1,3-butanediol, neopentyl glycol, glycerin, trimethylolmethane, pentaerythritol and dipentaerythritol. Examples of the metal hydroxide include hydroxides of alkali metals such as sodium and potassium. Examples of the metal alcoholate include those made of the above described alcohols and the above described metals. These are not limited to those listed as examples. The amounts of these reagents to be used are typically from 1 to 100 equivalents to the dialkyl boronate groups.

Second method: a method comprising subjecting a known thermoplastic resin having a carboxyl group and an amino group-containing boronic acid or amino group-containing boronic acid ester such as m-aminophenylbenzene boronic acid and m-aminophenylboronic acid ethylene glycol ester to an amidation reaction using a known method. In this method, a condensing agent such as carbodiimide may be employed. The boron-containing functional group introduced into a thermoplastic resin in such a way can be converted into another boron-containing functional group by the above-described method.

Examples of the thermoplastic resin containing a carboxyl group include, but are not restricted to, semiaromatic polyester resin, aliphatic polyester resin, etc. having a carboxyl group on their ends, resins resulting from introduction of monomer units having a carboxyl group such as acrylic acid, methacrylic acid and maleic anhydride to polyolefin resin, styrene resin, (meth)acrylate resin, vinyl halide-based resin, etc. by copolymerization, and resins resulting from introduction of maleic anhydride, etc. into the aforementioned thermoplastic resin containing an olefinic double bond by addition reaction.

The resin composition (E) included in the multi-layer structure of the present invention comprises an EVOH (A), a carboxylic acid-modified polyolefin (B), a thermoplastic resin (C) having a solubility parameter, calculated from the Fedors' equation, of 11 or less, and a thermoplastic resin (D) having at least one functional group selected from the group consisting of a boronic acid group and boron-containing groups capable of being converted into a boronic acid group in the presence of water.

It is preferable that the contents of the aforementioned raw materials in the resin composition (E) are 1 to 40% by weight of the EVOH (A), 0.1 to 39.1% by weight of the carboxylic acid-modified polyolefin (B), 59.8 to 98.8% by weight of the thermoplastic resin (C), and 0.1 to 39.1% by weight of the thermoplastic resin (D) having a boron-containing group. It is noted that the compounding ratios of the components (A) through (D) are ratios based on 100% by weight of the combined weight of (A) through (D). The compounding ratios of (A) through (D) are determined by taking into consideration balance between various properties, how easy to obtain, and price. In particular, when the resin composition (E) is prepared by using a regrind of a multi-layer structure, the compounding ratios of (A) through (C) vary depending on the performance which a multi-layer structure is required to have, but, in many cases, are compounding ratios within the above-mentioned ranges.

The content of EVOH (A) in the resin composition (E) is preferably from 1 to 40% by weight. When the content of EVOH (A) is less than 1% by weight, there may be no problems with respect to thermal stability even without addition of a thermoplastic resin (D) having a boron-containing group and, therefore, the necessity of adopting the present invention decreases. The content of EVOH (A) is more preferably 2% by weight or more, and even more preferably 3% by weight or more. On the other hand, when the content of EVOH (A) exceeds 40% by weight, the impact resistance may become insufficient. The content of EVOH (A) is more preferably 30% by weight or less, even more preferably 20% by weight or less, and particularly preferably 10% by weight or less.

The content of the carboxylic acid-modified polyolefin (B) in the resin composition (E) is preferably from 0.1 to 39.1% by weight. When the content of the carboxylic acid-modified polyolefin (B) is less than 0.1% by weight, there may be no problems with respect to thermal stability even without addition of a thermoplastic resin (D) having a boron-containing group and, therefore, the necessity of adopting the present invention decreases. The content of the carboxylic acid-modified polyolefin (B) is more preferably 0.3% by weight or more, and even more preferably 1% by weight or more. On the other hand, when the content of the carboxylic acid-modified polyolefin (B) exceeds 39.1% by weight, the impact resistance of a resulting multi-layer structure may become insufficient. The content of the carboxylic acid-modified polyolefin (B) is more preferably 20% by weight or less, and even more preferably 10% by weight or less.

The content of the thermoplastic resin (C) having a solubility parameter, calculated from the Fedors' equation, of 11 or less in the resin composition (E) is preferably from 59.8 to 98.8% by weight. When the main component of the resin composition (E) is the thermoplastic resin (C), the resin composition (E) can be used like the thermoplastic resin (C). The content of the thermoplastic resin (C) is more preferably 75% by weight or more, and even more preferably 89.4% by weight or more. When the content of the thermoplastic resin (C) exceeds 98.8% by weight, there may be no problems with respect to thermal stability even without addition of a thermoplastic resin (D) having a boron-containing group and, therefore, the necessity of adopting the present invention decreases. The content of the thermoplastic resin (C) is more preferably 96.4% by weight or less, and even more preferably 95% by weight or less.

The content of the thermoplastic resin (D) having at least one functional group selected from the group consisting of a boronic acid group and boron-containing groups capable of being converted into a boronic acid group in the presence of water in the resin composition (E) is preferably from 0.1 to 39.1% by weight. When the content of the thermoplastic resin (D) is less than 0.1% by weight, the compatibility of components (A), (B) and (C) in the resin composition (E) become insufficient and, therefore, impact resistance, thermal stability and appearance may become insufficient. In addition, in production of a thermoplastic resin (D) by use of a regrind, it may become difficult to carry out extrusion molding continuously. The content of the thermoplastic resin (D) is more preferably 0.3% by weight or more, even more preferably 1% by weight or more, and particularly preferably 3% by weight or more. In particular, in the case of reusing a regrind repeatedly, a higher content of the thermoplastic resin (D) is preferred. On the other hand, a thermoplastic resin (D) content of more than 39.1% by weight will result in a high cost. The content of the thermoplastic resin (D) is more preferably 20% by weight or less, and even more preferably 10% by weight or less.

The resin composition (E) can be prepared easily by melt kneading of the above predetermined amounts of components (A)-(D) using a normal melt kneading machine such as a Banbury mixer, a single or twin screw extruder, etc. The melt kneading machine is not particularly restricted. However, it is preferable to use an extruder, which can achieve a high kneading degree, in order to blend the components uniformly. In addition, in order to prevent occurrence or contamination of gels or hard spots, it is preferable to seal a hopper with nitrogen gas and to conduct extrusion at a low temperature. At this time, antioxidants, plasticizers, heat stabilizers, UV absorbers, antistatic agents, lubricants, colorants, fillers or other resins may be added, unless the effect of the present invention is inhibited.

In this case, it is preferable to use of each of the components (A)-(C) with whole or partial replacement by regrind, such as wastes, burrs, chips of products or defective products produced during the production of multi-layer structures composed of layers including the components (A)-(C) because recovered materials can be reused effectively. The regrind is not restricted to one composed only of the components (A)-(C) and may include thermoplastic resins which can form multi-layer structures like those described later, which are typified by a thermoplastic resin (D) having a boron-containing group. Since regrind is usually uneven in size, it is preferable to grind it into a proper size before use.

When mixing a thermoplastic resin (C) having a boron-containing group to such regrind, followed by melt kneading, the compatibility between the components (A)-(C) is improved dramatically and it becomes easy to continue the production of a regrind composition. Specifically, it is preferable to form a layer of a resin composition (E) by adding a thermoplastic resin (D) having a boron-containing group to a regrind obtained from a multi-layer structure comprising a layer of an EVOH (A), a layer of a carboxylic acid-modified polyolefin (B) and a layer of a thermoplastic resin (C) followed by melt-kneading. In other words, the thermoplastic resin (D) having a boron-containing group is used as a regrind aid added at the time of use of a regrind.

In this situation, the regrind is preferably one obtained from a multi-layer structure further including a layer of a resin composition (E) having a boron-containing group in addition to the layer of an EVOH (A), the layer of a carboxylic acid-modified polyolefin (B) and the layer of a thermoplastic resin (C). This case corresponds to a case where by using, as a raw material, a multi-layer structure having a resin composition (E) obtained by addition of a thermoplastic resin (D) to a regrind, followed by melt kneading, a regrind is obtained again and then a multi-layer structure is produced which has a layer of a resin composition (E) obtained by addition of a thermoplastic resin (D) to the regrind, followed by melt kneading. In other words, it corresponds to a case of conducting a scrap regrind operation again. In usual cases where multi-layer structures having a regrind composition layer are produced continuously in an industrial scale, the use of regrind is repeated many times. Even in such cases, it is possible to carry out melt molding with good thermal stability.

It is preferable that the thermoplastic resin (D) having a boron-containing group is added in an amount of 0.1 to 30 parts by weight based on 100 parts by weight in total of the regrind and the thermoplastic resin (D) to be added thereto, followed by melt-kneading. When the content of the thermoplastic resin (D) is less than 0.1% by weight, the compatibility of components (A), (B) and (C) in the resin composition (E) become insufficient and, therefore, impact resistance, thermal stability and appearance may become insufficient. In the production of a thermoplastic resin (D) by using a regrind, it may become difficult to reuse a regrind by extrusion molding continuously or by repeating regrinding. The amount of the thermoplastic resin (D) added is more preferably 0.3 parts by weight or more, even more preferably 1 part by weight or more, and particularly preferably 3 parts by weight or more. On the other hand, addition of the thermoplastic resin (D) at an amount of more than 39.1% by weight will result in a high cost. The amount of the thermoplastic resin (D) added is more preferably 20% by weight or less, and even more preferably 10% by weight or less.

It is also preferable to obtain a resin composition (E) by further mixing a component (C) in addition to the regrind including the components (A)-(C) and the thermoplastic resin (D) having a boron-containing group. This makes it, in many cases, possible to obtain a resin composition (E) showing properties comparable to those of the component (C) itself. For example, it can be used also as a main layer of multi-layer structures described later.

The multi-layer structure of the present invention has, in addition to the layer of the resin composition (E), a layer of an ethylene-vinyl alcohol copolymer (A) having an ethylene content of 5 to 60 mol % and a degree of saponification of 85% or more, a layer of a carboxylic acid-modified polyolefin (B), a layer of a thermoplastic resin (C) having a solubility parameter, calculated from the Fedors' equation, of 11 or less. It is noted that the layer of an EVOH (A) is laminated with the layer of a resin composition (C) or the layer of a resin composition (E) through the layer of a carboxylic acid-modified polyolefin (B). In other words, the layer of a carboxylic acid-modified polyolefin (B) is used as an adhesives layer to be used between the layer of (A) and the layer of (C) or layer (E). The carboxylic acid-modified polyolefin (B) is excellent in performance as an adhesive and preferable in cost aspect. It is also excellent in melt molding processability at the time of fabricating multi-layer structures.

In the multi-layer structure of the present invention, polyester (polyethylene terephthalate, polybutylene terephthalate, etc.), polyamide, polycarbonate, polyvinyl chloride, polyvinylidene chloride, polyurethane, polyacetal, etc. may be mentioned in addition to the layer of EVOH (A), the layer of a carboxylic acid-modified polyolefin (B), the layer of a thermoplastic resin (C) and the layer of a resin composition (E).

The layer structure of a multi-layer structure is not particularly restricted and examples thereof include four-layer structure such as A/B/E/C and A/B/C/E; five-layer structure such as E/B/A/B/C, E/B/A/B/E, and A/B/E/B/C; six-layer structure such as C/B/A/B/E/C and E/B/A/B/E/C; seven-layer structure such as E/B/A/B/A/B/C and C/E/B/A/B/E/C. In multi-layer structure having the same type of layers, e.g., two or more layers of EVOH (A), the EVOHs forming the layers may be the same or different. This is also true for other component layers. It is also possible to further add a layer of another component to the layer structures shown above. Among these, multi-layer structures having five or more layers are preferred because they are of high practicality and can be used for various applications.

As the method for producing the multi-layer structure of the present invention, known methods may be used. For example, extrusion coating, co-extrusion molding and co-injection molding can be used. In particular, co-extrusion molding or co-injection molding is preferably used. It is also possible to produce a multi-layer sheet or a multi-layer film once by such a method and then further conduct co-orientation, rolling, thermoforming, etc.

Among these, co-extrusion is preferable because the process is simple, it is possible to produce even laminates with a complicated layer structure relatively easily, and the production cost can be saved. On the other hand, co-injection molding, which is unsuitable for preparation of a complicated layer structure, is advantageous in a productivity aspect due to a short production cycle. Thermoforming, which needs a complicated process, can produce long-shaped containers, etc., which is difficult to be produced by co-injection molding. A molding method is suitably selected depending, for example, upon the shape and application of a molded article to be produced.

The shape of the multi-layer structure may be, but is not restricted to, a cup, a bottle, a tube and a tank, etc. as well as a sheet and a film. The multi-layer structure has various applications, e.g., packaging materials or containers of foods, pharmaceuticals, medical instruments and clothes, and tubes, tanks, etc. for fuel (e.g., gasoline). Among these, fuel containers, which are particularly important, are described below.

When the multi-layer structure is a fuel container, the layer structure thereof is not particularly restricted. Taking into consideration molding processability and cost, however, typical examples include (inside) C/B/A/B/E (outside), (inside) C/B/A/B/E/C (outside), and (inside) C/E/B/A/B/E/C (outside). Among these, it is particularly preferable to adopt a layer structure (inside) C/B/A/B/E/C (outside) from the viewpoints of rigidity, impact resistance, molding processability, drawdown resistance and fuel resistance.

The thickness of each layer of a fuel container is not particularly limited. Taking into consideration fuel barrier property and mechanical strength of a fuel container and cost merit, however, the thickness of the layer of the EVOH (A) is preferably 0.1% or more, more preferably 0.5% or more, and even more preferably 1% or more, based on the overall thickness of all the layers. The thickness of the layer of the EVOH (A) is preferably 20% or less, more preferably 15% or less, and even more preferably 10% or less, based on the overall thickness of all the layers. When there are two or more layers of EVOH (A), the total of the thicknesses of the layers of EVOH (A) is defined as the thickness of the layer of EVOH (A). When the thickness of the layer of EVOH (A) is less than 0.1% of the overall thickness of all the layer, the fuel container may have an insufficient fuel barrier property. When the thickness exceeds 20%, the product is comparatively expensive and it may have an insufficient mechanical strength.

Fuel containers are produced preferably by co-extrusion blow molding. Specifically, a parison is formed by melt extrusion and it is held in a pair of mold halves for blow molding. Thus, the parison is pinched and the opposite pinched portions are melt bonded together. Then, the pinched parison is inflated inside the mold to be shaped into a fuel container. It is noted that in the case of a large container such as a fuel tank for automobiles, while a parison is held with the mold halves and closed by compression, portions protruding from the container surface are cut off at a desired level with a cutter or the like without pinching off with the mold halves.

A fuel container can be produced also by thermoforming upper and lower multi-layer sheets separately and then melt bonding these two formed articles together by heat welding or the like. In particular, this method can produce a long-shaped tank, which is difficult to be produced by co-extrusion blow molding.

### EXAMPLES

The present invention will be described in more detail below by way of Examples, by which, however, the invention is not limited at all. In the following Examples and Comparative Examples, a ratio means a weight ratio and “%” means “% by weight” unless otherwise stated. Melt flow rate (MFR) is a value measured at 190° C. and a load of 2160 g, unless otherwise stated. Intrinsic viscosity is a value measured at 30° C. using a solution prepared by use of a mixed solvent of 85% by weight of phenol and 15% by weight of water.

### Synthesis Example 1

### Preparation of High Density Polyethylene Having an Ethylene Glycol Boronate Group at an End Thereof

In a separable flask equipped with a cooler, a stirrer and a dropping funnel, 1000 g of high density polyethylene {MFR=0.3 g/10 min (at 190° C., under 2160 g load), density=0.952 g/cm³, amount of end double bonds=0.048 meq/g (mmol/g)} and 2500 g of decalin were added. After degassing by reducing pressure at room temperature, the atmosphere was replaced by nitrogen. To this system, 78 g of trimethyl borate and 5.8 g of borane-triethylamine complex were added. After a reaction was continued at 200° C. for 4 hours, a distillation instrument was attached and 100 ml of methanol was dropped slowly. After the completion of the methanol dropping, low-boiling impurities such as methanol, trimethyl borate and triethylamine were distilled off by distillation under reduced pressure. After further addition of 31 g of ethylene glycol, followed by stirring for 10 minutes, reprecipitation was conducted in acetone, followed by drying. Thus, a modified polyethylene (d-1: BEAG-modified HDPE) having an ethylene glycol boronate group content of 0.027 meq/g (mmol/g), an MFR of 0.3 g/10 min (at 190° C., under 2160 g load) and a density of 0.952 g/cm³ was obtained. The amount of ethylene glycol boronate groups (BAEG) in the modified polyethylene was determined by preparing a solution using a mixed solution with ratios of deuterated paraxylene:deuterated chloroform:ethylene glycol=8:2:0.02 as a solvent and measuring 270-MHz ¹H-NMR.

### Synthesis Example 2

### Preparation of Very Low Density Polyethylene Having an Ethylene Glycol Boronate Group at an End Thereof

In a separable flask equipped with a cooler, a stirrer and a dropping funnel, 1000 g of very low density polyethylene {MFR=15 g/10 min (at 190° C., under 2160 g load), density=0.900 g/cm³, amount of end double bonds=0.055 meq/g (mmol/g)} and 2500 g of decalin were added. After degassing by reducing pressure at room temperature, the atmosphere was replaced by nitrogen. To this system, 78 g of trimethyl borate and 5.8 g of borane-triethylamine complex were added. After a reaction was continued at 200° C. for 4 hours, a distillation instrument was attached and 100 ml of methanol was dropped slowly. After the completion of the methanol dropping, low-boiling impurities such as methanol, trimethyl borate and triethylamine were distilled off by distillation under reduced pressure. After further addition of 31 g of ethylene glycol, followed by stirring for 10 minutes, reprecipitation was conducted in acetone, followed by drying. Thus, a modified polyethylene (d-2: BEAG-modified VLDPE) having an ethylene glycol boronate group content of 0.050 meq/g, an MFR of 15 g/10 min (at 190° C., under 2160 g load) and a density of 0.900 g/cm³ was obtained. The amount of ethylene glycol boronate groups (BAEG) in the modified polyethylene was determined by the method the same as that in Synthesis Example 1.

### Referential Example 1

To a twin screw type vented extruder, 1 part by weight of modified polyethylene (d-1: BEAG-modified HDPE) prepared in Synthesis Example 1, 5 parts by weight of EVOH made by Kuraray Co., Ltd. “EVAL®-F101” (ethylene content=32 mol %, degree of saponification=99.5%, intrinsic viscosity=1.1 dl/g), 8 parts by weight of maleic anhydride-modified polyethylene made by Mitsui Chemicals, Inc. “ADMER® GT6” {MFR=0.94 g/10 min (at 190° C., under 2160 g load)}, and 86 parts by weight of high density polyethylene made by Bassel “Lupolen® 4261AG” (MFR=0.03 g/10 min (at 190° C., under 2160 g load), density=0.945 g/cm³) were fed, followed by extrusion pelletization at 220° C. under a nitrogen atmosphere. Thus, pellets of a resin composition was obtained.

Evaluation of Film Appearance

Using the pellets obtained, a film was produced by use of a machine shown below and the appearance of the film was evaluated.

Machine used: twin screw extruder made by Toyo Seiki Seisaku-Sho, Ltd.

Screw: 20 mmφ, full flight

Extrusion temperature: 190/260/260/260° C.

Film thickness: 100 μm

Measurement of Impact Strength

Using the pellets obtained, a specimen was prepared by injection molding using a single screw extruder. The IZOD impact strength thereof was measured at −40° C. in accordance with ASTM D256. An impact strength analyzer was placed in a thermostatic chamber adjusted to −40° C. A sample to be measured was stored in the thermostatic chamber at least overnight before measurement and then the impact strength thereof was measured at −40° C.

Amount of Residual Resin

Using the pellets obtained, an extrusion test was conducted using a machine shown below. Following 60-minutes kneading, “MIRASON 102” (LDPE) made by Mitsui Chemicals, Inc. was added, and kneading was continued for 45 min using the above-mentioned resin. During this operation, the test pellets purged out of the upper portion of the rotor. After removing out the LDPE, the weight of resin adhering to the rotor surface was measured.

Machine used: extruder Brabender made by Toyo Seiki Seisaku-Sho, Ltd.

Extrusion temperature: 220° C.

Rotation speed: 50 rpm

Kneading under nitrogen atmosphere for 60 min

The results of the above-described evaluations are summarized in Table 1.

### Referential Examples 2, 3

Pellets of a resin composition were prepared in the same manner as Referential Example 1 except for changing the amounts of the resins used as shown in Table 1, followed by evaluation of film appearance, measurement of impact strength and measurement of the amount of residual resin. The results are summarized in Table 1.

### Referential Example 4

Into a twin screw type vented extruder, 5 parts by weight of EVOH made by Kuraray Co., Ltd. “EVAL®-F101” (ethylene content=32 mol %, degree of saponification=99.5%, intrinsic viscosity=1.1 dl/g), 8 parts by weight of maleic anhydride-modified polyethylene made by Mitsui Chemicals, Inc. “ADMER® GT6”, and 87 parts by weight of high density polyethylene made by Bassel “Lupolen® 4261AG” were fed, followed by extrusion pelletization at 220° C. under a nitrogen atmosphere. Thus, pellets of a resin composition was obtained. Using the pellets obtained, evaluation of film appearance, measurement of impact strength and measurement of the amount of residual resin were conducted in the same manners as in Example 1. The results are summarized in Table 1.

### Referential Examples 5 to 7

Pellets of a resin composition were prepared in the same manner as Referential Example 4 except for changing the amounts of the resins used as shown in Table 1, followed by evaluation of film appearance, measurement of impact strength and measurement of the amount of residual resin. The results are summarized in Table 1.

TABLE 1

| | Compounding amount of resin | | | | | | |
|---|---|---|---|---|---|---|---|
| | (parts by weight) | | | | | | |
| | | Carboxylic | Thermo- | | | | |
| | | acid- | plastic | | Evaluation results | | |
| | | modified | resin | BAEG- | Film | Impact | Amount of |
| | EVOH | polyolefin | (HDPE) | modified | appear- | strength | residual |
| | (A) | (B) | (C) | resin (D) | ance | (kJ/m²) | resin (g) |
| Referential | 5 | 8 | 86 | 1 | Good | 68 | 0.6 |
| Example 1 | | | | | | | |
| Referential | 5 | 8 | 84 | 3 | Good | Not | 0.4 |
| Example 2 | | | | | | broken | |
| Referential | 5 | 8 | 82 | 5 | Good | Not | 0.3 |
| Example 3 | | | | | | broken | |
| Referential | 5 | 8 | 87 | 0 | Streaks | 47 | 2 |
| Example 4 | | | | | occurred | | |
| Referential | 5 | 9 | 86 | 0 | Streaks | 52 | 1.5 |
| Example 5 | | | | | occurred | | |
| Referential | 5 | 13 | 82 | 0 | Streaks | 68 | 1.2 |
| Example 6 | | | | | occurred | | |
| Referential | 5 | 18 | 77 | 0 | Streaks | 79 | 0.9 |
| Example 7 | | | | | occurred | | |

As shown in Table 1, it was found that blending of a thermoplastic resin (D) having a boron-containing functional group into a resin composition comprising an EVOH (A), a carboxylic acid-modified polyolefin (B) and a thermoplastic resin (C) improved appearance and impact strength of molded articles and reduced the amount of residual resin. This effect becomes more remarkable as the amount of the thermoplastic resin (D) added increases. The addition of the thermoplastic resin (D) having a boron-containing functional group appears to contribute greatly to the compatibility of the components and thermal stability.

### Example 1

Using EVOH made by Kuraray Co., Ltd. “EVAL®-F101” (ethylene content=32 mol %, degree of saponification=99.5%, intrinsic viscosity=1.1 dl/g) (EVOH), maleic anhydride-modified polyethylene made by Mitsui Chemicals, Inc. “ADMER® GT6” (AD), and high density polyethylene made by Bassel “Lupolen® 4261AG” (HDPE), a sheet having a layer structure of HDPE/AD/EVOH/AD/HDPE=510/20/30/20/420 μm was produced by use of the multi-layer extrusion machine shown below. Then, the resulting multi-layer sheet was ground into a size proper for being fed into the extruder. To 90 parts by weight of the ground matter, 10 parts by weight of the modified polyethylene (d-1: BEAG-modified HDPE) prepared in Synthesis Example 1 was dry blended to yield a raw material of a regrind layer (Reg 1). Using this raw material and the resins provided above, a sheet having a layer structure of HDPE/Reg1/AD/EVOH/AD/HDPE=110/400/20/30/20/420 μm was produced by use of the multi-layer extrusion machine shown below. The resulting multi-layer sheet was ground in the same manner as that previously used. To 90 parts by weight of this ground matter, 10 parts by weight of the modified polyethylene (d-1) was dry blended to yield a raw material of the next regrind layer (Reg 2). After repeating this operation five times, a screw used for the extrusion of the fifth regrind layer (Reg 5) was removed from the extruder and the state of residual resin on the screw was visually observed. As a result, there was so little residual resin that it could be removed easily. In addition, using the raw material of the fifth regrind layer (Reg 5), pelletization was carried out at 210° C. and the condition of generation of die-lip build up adhering on a strand after one hour was observed visually. As a result, no generation of die-lip build up was found.

Constitution of Multi-Layer Extruding Machine:

Extruder 1 for HDPE Screw diameter: 25 mm, Temperature: 190° C.

Extruder 2 for HDPE or for Reg Screw diameter: 40 mm, Temperature: 210° C.

Extruder 3 for AD Screw diameter: 20 mm, Temperature: 190° C.

Extruder 4 for EVOH Screw diameter: 20 mm, Temperature: 210° C.

Extruder 5 for AD Screw diameter: 20 mm, Temperature: 190° C.

Extruder 6 for HDPE Screw diameter: 40 mm, Temperature: 210° C.

All the screws are screws called full flight, which have no kneading section.

### Comparative Example 1

A multi-layer sheet having a regrind layer was prepared in the same manner as Example 1, except for failing to blend modified polyethylene (d-1) into a ground matter of a multi-layer sheet as a raw material for regrind layers (Reg n, n=integer of from 1 to 5). A screw used for the extrusion of the fifth regrind layer (Reg 5) was removed from the extruder and the state of residual resin on the screw was visually observed. As a result, there was much residual resin and it took considerable time and effort for removing the resin. In addition, when pelletization was conducted at 210° C. using the raw material of the fifth regrind layer (Reg 5), die-lip build up was formed remarkably. It is presumed that increase in the number of regrind leads to deterioration in thermal stability of the carboxylic acid-modified polyolefin, resulting in deterioration in dispersibility of the EVOH in the regrind layers. In other words, it became clear that addition of a thermoplastic resin (D) having a boron-containing group greatly improves the thermal stability of a regrind composition.

### Example 2

Using EVOH made by Kuraray Co., Ltd. “EVAL®-F101” (ethylene content=32 mol %, degree of saponification=99.5%, intrinsic viscosity=1.1 dl/g) (EVOH) maleic anhydride-modified polyethylene made by Mitsui Chemicals, Inc. “ADMER® GT6” (AD), and high density polyethylene made by Bassel “Lupolen® 4261AG” (HDPE), a sheet having a layer structure of HDPE/AD/EVOH/AD/HDPE=510/20/30/20/420 μm was produced by use of the multi-layer extrusion machine shown above. Then, the resulting multi-layer sheet was ground into a size proper for being fed into the extruder. To 95 parts by weight of the ground matter, 5 parts by weight of the modified polyethylene (d-2: BEAG-modified VLDPE) prepared in Synthesis Example 2 was dry blended to yield a raw material of a regrind layer (Reg 1). Using this raw material and the resins provided above, a sheet having a layer structure of HDPE/Reg1/AD/EVOH/AD/HDPE=110/400/20/30/20/420 μm was produced by use of the multi-layer extrusion machine the same as that used in Example 1 under the same conditions. The resulting multi-layer sheet was ground in the same manner as that previously used. To 95 parts by weight of this ground matter, 5 parts by weight of the modified polyethylene (d-2) was dry blended to yield a raw material of the next regrind layer (Reg 2). A multi-layer sheet produced by using Reg 5 obtained after five time repetition of this operation was evaluated for appearance and impact strength. The appearance of the multi-layer sheet was evaluated by visual observation. Regarding the impact resistance, a test piece was prepared from the resulting multi-layer sheet with a dumbbell cutter provided in ASTM-D1829 and then a TIS (tensile impact strength) was measured at −40° C., in the MD direction at n=10. In addition, after five time repetition of the above operation, the fifth regrind layer (Reg 5) was ground, followed by pelletization at 210° C. Then, the condition of generation of die-lip build up adhering on a strand after one hour was observed visually. As a result, no generation of die-lip build up was found.

### Example 3

Tests and evaluations were conducted in the same manner as Example 2 except repeating the operation of preparing a multi-layer sheet by dry blending 10 parts by weight of the modified polyethylene (d-2: BEAG-modified VLDPE) to 90 parts by weight of the ground matter. The results are summarized in Table 2.

### Example 4

Tests and evaluations were conducted in the same manner as Example 2 except repeating the operation of preparing a multi-layer sheet by dry blending 5 parts by weight of the modified polyethylene (d-1: BEAG-modified HDPE) prepared in Synthesis Example 1 to 95 parts by weight of the ground matter. The results are summarized in Table 2.

### Comparative Example 2

Tests and evaluations were conducted in the same manner as Example 2 except repeating the operation of preparing a multi-layer sheet by dry blending 5 parts by weight of a maleic anhydride-modified polyethylene “ADMER® GT6” to 95 parts by weight of the ground matter. The results are summarized in Table 2.

### Comparative Example 3

Tests and evaluations were conducted in the same manner as Example 2 except repeating the operation of preparing a multi-layer sheet by adding nothing to the ground matter. The results are summarized in Table 2.

TABLE 2

| | | The | | | |
|---|---|---|---|---|---|
| | | addition | | Impact | Generation of |
| | | amount to | Appearance | strength of | die-lip build |
| | Thermo- | regrind | of | multi-layer | up in |
| | plastic | (parts by | multi-layer | sheet | pelletization |
| | resin (D) | weight) | sheet | (kJ/m²) | of Reg 5 |
| Example 2 | BEAG-modified | 5 | Good | 120 | None |
| | VLDPE | | | | |
| Example 3 | BEAG-modified | 10 | Good | 140 | None |
| | VLDPE | | | | |
| Example 4 | BEAG-modified | 5 | Good | 100 | None |
| | HDPE | | | | |
| Comparative | MAn-modified | 5 | A little | 70 | Generated |
| Example 2 | HDPE | | unevenness | | remarkably |
| | | | in surface | | |
| Comparative | — | Not added | Much | 50 | Generated |
| Example 3 | | | unevenness | | remarkably |
| | | | in surface | | |

As shown in Table 2, it was found that in Examples 2 to 4 where a thermoplastic resin (D) having a boron-containing functional group was added to a regrind comprising an EVOH (A), a carboxylic acid-modified polyolefin (B) and a thermoplastic resin (C), generation of die-lip build up during pelletization was inhibited due to improvement in thermal stability and resulting sheets are excellent in appearance and impact resistance. On the other hand, in Comparative Example 2 where a carboxylic acid-modified polyethylene was added instead of the thermoplastic resin (D) having a boron-containing functional group, die-lip build up occurred remarkably and a resulting multi-layer sheet worsened in appearance and impact resistance. In Comparative Example 3 where nothing was added to a regrind, a resulting multi-layer sheet worsened in appearance and impact resistance more. As shown by comparison of Example 2 with Example 4, it was found that use of a thermoplastic resin (D) including a polyethylene with a lower density affords a multi-layer sheet with better impact resistance.

### Example 5

Using the Reg5 prepared in Example 2, a 750-ml multi-layer bottle having a structure of HDPE/Reg5/AD/EVOH/AD/HDPE was produced by co-extrusion blow molding under the conditions shown below. The layer structure near the center of the bottle body was 110/400/20/30/20/420 μm. Visual evaluation of the appearance of the resulting multi-layer bottle revealed that the appearance was satisfactory. A flat central portion of the bottle was sampled and a test piece was prepared with a dumbbell cutter provided in ASTM-D1829. Then, a TIS (tensile impact strength) was measured at −40° C., in the MD direction at n=10 to be 110 kJ/m² and the test piece exhibited good impact resistance.

Co-Extrusion Blow Molding Conditions

Molding machine: Four-kind seven-layer direct blow molding machine manufactured by Suzuki Tekkosho Co.

HDPE extrusion temperature: 190° C.

Reg 5 extrusion temperature: 190° C.

AD extrusion temperature: 180° C.

EVOH extrusion temperature: 205° C.

Mold temperature: 80° C.

### Comparative Example 4

Using the Reg 5 prepared in Comparative Example 3, a multi-layer bottle was produced and evaluation was conducted in the same manner as Example 5. Visual observation of the appearance of the resulting multi-layer bottle revealed that there was much unevenness in the surface. A flat central portion of the bottle was sampled and a test piece was prepared with a dumbbell cutter provided in ASTM-D1829. Then, a TIS (tensile impact strength) was measured at −40° C., in the MD direction at n=10 to be 50 kJ/m² and the test piece exhibited insufficient impact resistance.

1. A multi-layer structure comprising a layer of an ethylene-vinyl alcohol copolymer (A) having an ethylene content of 5 to 60 mol % and a degree of saponification of 85% or more, a layer of a carboxylic acid-modified polyolefin (B), a layer of a thermoplastic resin (C) having a solubility parameter, calculated from the Fedors' equation, of 11 or less, and a layer of a resin composition (E),
wherein the resin composition (E) comprises an ethylene-vinyl alcohol copolymer (A), a carboxylic acid-modified polyolefin (B), a thermoplastic resin (C) and a thermoplastic resin (D) having at least one functional group selected from the group consisting of a boronic acid group and boron-containing groups capable of being converted into a boronic acid group in the presence of water, and
wherein the layer of an ethylene-vinyl alcohol copolymer (A) and the layer of a thermoplastic resin (C) or the layer of a resin composition (E) are laminated through the layer of a carboxylic acid-modified polyolefin (B).

2. The multi-layer structure according to claim 1, wherein the resin composition (E) comprises 1 to 40% by weight of an ethylene-vinyl alcohol copolymer (A), 0.1 to 39.1% by weight of a carboxylic acid-modified polyolefin (B), 59.8 to 98.8% by weight of a thermoplastic resin (C) and 0.1 to 39.1% by weight of a thermoplastic resin (D).

3. The multi-layer structure according to claim 1 or 2, wherein the thermoplastic resin (C) is a substantially unmodified polyolefin.

4. The multi-layer structure according to any one of claims 1 to 3, wherein the content of boron-containing groups in the thermoplastic resin (D) is 0.001 to 2 meq/g.

5. The multi-layer structure according to any one of claims 1 to 4, wherein the thermoplastic resin (D) is a polyolefin having at least one functional group selected from the group consisting of a boronic acid group and boron-containing groups capable of being converted into a boronic acid group in the presence of water.

6. The multi-layer structure according to claim 5, wherein the thermoplastic resin (D) is a polyethylene having a density of 0.85 to 0.94 g/cm³.

7. An extrusion molded article comprising the multi-layer structure according to any one of claims 1 to 6.

8. A blow molded article comprising the multi-layer structure according to any one of claims 1 to 6.

9. A thermoformed article comprising the multi-layer structure according to any one of claims 1 to 6.

10. A fuel container comprising the multi-layer structure according to any one of claims 1 to 6.

11. A method for producing the multi-layer structure according to any one of claims 1 to 6 comprising adding a thermoplastic resin (D) to a regrind obtained from a multi-layer structure comprising a layer of an ethylene-vinyl alcohol copolymer (A), a layer of a carboxylic acid-modified polyolefin (B) and a layer of a thermoplastic resin (C) followed by melt-kneading to form a layer of a resin composition (E).

12. The method for producing the multi-layer structure according to claim 11, wherein the regrind is one obtained from a multi-layer structure further comprising a layer of a resin composition (E) in addition to the layer of an ethylene-vinyl alcohol copolymer (A), the layer of a carboxylic acid-modified polyolefin (B) and the layer of a thermoplastic resin (C).

13. The method for producing the multi-layer structure according to claim 11 or 12, wherein the thermoplastic resin (D) is added in an amount of 0.1 to 30 parts by weight based on 100 parts by weight in total of the regrind and the thermoplastic resin (D) to be added thereto, followed by melt-kneading.

14. The method for producing the multi-layer structure according to any of claims 11 to 13, wherein co-extrusion molding or co-injection molding is carried out.
